(19) United States
(12) Patent Application Publication
(10) Pub. No.: US 2025/0205676 A1
(43) Pub. Date: Jun. 26, 2025

(54) OPEN-CHANNEL SUPPORTED METAL-ORGANIC FRAMEWORK BASED GASEOUS CONTAMINANT REMOVAL

(71) Applicant: Blue Origin, LLC, Kent, WA (US)

(72) Inventors: John P. Stanford, Kent, WA (US); Ariane B. Chepko, Redmond, WA (US); Susan C. Doll, Kent, WA (US); Michael Dean Wales, Kent, WA (US)

(21) Appl. No.: 18/393,455

(22) Filed: Dec. 21, 2023

(51) Int. Cl. B01J 20/22; B01D 53/62; B01D 53/82; B01D 53/96; B01J 20/32; B01J 20/34

(52) U.S. Cl. CPC B01J 20/226; B01D 53/62; B01D 53/82; B01D 53/96; B01J 20/3204; B01J 20/3425; B01J 20/3441; B01J 20/3483; B01D 2253/204; B01D 2253/34; B01D 2257/504; B01D 2259/40088; B01D 2259/4575

(57) ABSTRACT

A system for regenerative carbon dioxide (CO2) removal in spacecraft cabin environmental conditions is described. Metal organic framework (MOF) adsorbents are integrated onto an oxide coated support material, such as a thin sheet or wire/wire mesh and implemented in an open-channel architecture. The support material may be titanium having an oxide surface layer that comprises titanium dioxide (TiO2) nanotubes. These structures provide a relatively large surface area for hosting MOF adsorbents. An integrated titanium support structure with MOFs may be more energy efficient and have greater flexibility in gas (e.g., air) flowrate as compared to traditional configurations of a packed bed reactor containing a pelletized form of adsorbent, such as zeolite.

### BACKGROUND

### Technical Field

The present disclosure relates generally to gaseous contaminant removal systems and methods. More particularly, the present disclosure relates to open-channel supported metal-organic framework based gaseous contaminant removal.

### Description of the Related Art

An important aspect of air revitalization for life support in spacecraft is the removal of carbon dioxide from cabin air. Several types of carbon dioxide removal systems have been in use for spacecraft life support systems. These systems rely on various removal techniques that employ different architectures and media for scrubbing CO2, such as permeable membranes, liquid amine, adsorbents, and absorbents. Sorbent systems have been used since the first manned space missions.

A technique for carbon dioxide removal may utilize a regenerable solid sorbent technology comprising a combination of zeolites and desiccants in packed bed reactors. Though this technique has been used for many years, it has a number of problems. For example, zeolite beds generally produce a relatively high pressure drop. Also, dusting problems may occur, causing downstream component failures arising from zeolite pellet degradation due to humidity and temperature cycles. The specific density and heat capacity of the adsorbent material generally leads to high heating requirements. Moreover, low CO2/H2O selectivity of zeolites may lead to the need for desiccant beds upstream of the zeolites.

### SUMMARY

The embodiments disclosed herein each have several aspects no single one of which is solely responsible for the present disclosure's desirable attributes. Without limiting the scope of the present disclosure, its more prominent features will now be briefly discussed. After considering this discussion, and particularly after reading the section entitled “Detailed Description” one will understand how the features of the embodiments described herein provide advantages over existing gaseous contaminant removal systems and methods.

In various implementations, a carbon dioxide (CO2) removal reactor system is provided. The CO2 removal reactor system can include a metal substrate having a surface, a nanotube oxide layer on the surface of the metal substrate, and a metal organic framework (MOF) adsorbent disposed on the nanotube oxide layer.

In some embodiments, the metal substrate is a wire mesh. In some embodiments, the metal substrate is a sheet or hollow rod. In some instances, the metal substrate can be a titanium substrate.

In some CO2 removal reactor systems, the MOF is disposed inside individual nanotubes of the nanotube oxide layer. In some instances, the MOF is disposed substantially at openings of individual nanotubes of the nanotube oxide layer.

Some embodiments further include an electrode connected to the metal substrate to carry electricity to regenerate at least a portion of the CO2 removal reactor system.

Some embodiments further include a heating element connected to the metal substrate to carry heat to regenerate at least a portion of the CO2 removal reactor system.

In various implementations, a carbon dioxide (CO2) removal system is provided. The CO2 removal system can include an open channel that includes a metal substrate having a surface, a nanotube oxide layer on the surface of the metal substrate, and a metal organic framework (MOF) adsorbent disposed on the nanotube oxide layer.

In some embodiments, the metal substrate is a wire mesh that extends across at least a portion of the open channel. In some embodiments, the metal substrate is a sheet or hollow rod that is oriented longitudinally in the open channel.

In some embodiments, the CO2 removal system is disposed in a spacecraft.

In some instances, the metal substrate is a titanium substrate.

In some CO2 removal systems, the MOF is disposed inside individual nanotubes of the nanotube oxide layer.

Some embodiments further include an electrode connected to the metal substrate to carry electricity to regenerate at least a portion of the CO2 removal reactor system.

Some embodiments further include a heating element connected to the metal substrate to carry heat to regenerate at least a portion of the CO2 removal reactor system.

In various implementations, a method of removing carbon dioxide (CO2) from a cabin of a spacecraft is provided. The method can include conveying air from the cabin into an open channel and past a titania support structure located in an open channel. The air can include CO2 and the titania support structure can include a metal organic framework (MOF) adsorbent. The method can also include providing the air that has passed the titania support structure to the cabin.

In some embodiments, the titania support structure is a wire mesh that extends across at least a portion of the open channel. In some embodiments, the titania support structure is a sheet that is oriented longitudinally in the open channel. In some embodiments, the titania support structure is a rod that is oriented longitudinally in the open channel.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a schematic perspective view of a titanium dioxide (titania) nanotube array, according to some embodiments.

FIG. 2 is a top view of a titania nanotube array, according to some embodiments.

FIG. 3 is a cross-section view of a titania nanotube array, according to some embodiments.

FIG. 4 is a cross-section view of another titania nanotube array, according to some embodiments.

FIG. 5 is a cross-section view of a titania nanotube including a coating of a metal organic framework, according to some embodiments.

FIG. 6 is a cross-section view of a titania nanotube including a metal organic framework at its opening, according to some embodiments.

FIG. 7 is a cross-section view of another titania nanotube including a metal organic framework at its opening, according to some embodiments.

FIG. 8 is a cross-section view of a support structure including a metal organic framework on its surface, according to some embodiments.

FIG. 9 is a schematic view of an open channel reactor including linear structures that support a metal organic framework, according to some embodiments.

FIG. 10 is a schematic view of an open channel reactor including wire mesh structures that support a metal organic framework, according to some embodiments.

### DETAILED DESCRIPTION

This disclosure describes architectures and methods for, among other things, regenerative carbon dioxide (CO2) removal in various closed-vessel environmental conditions, such as those found in a spacecraft cabin or submarine. Though examples and discussions herein generally focus on carbon dioxide removal, the architectures and methods need not be so limited and may also be used for gaseous contaminant removal. In some embodiments, metal organic framework (MOF) adsorbents are integrated onto an oxide coated support material, such as a thin sheet or wire/wire mesh, and implemented in an open-channel architecture. The support material may be a metal oxide such as titanium having an oxide surface layer that comprises titanium dioxide (TiO2) nanotubes, which are often called titania nanotubes. These structures provide a relatively large surface area for hosting MOF adsorbents (hereinafter called “MOFs”) to adsorb CO2 (or other gaseous contaminant). Herein, the underlying titanium is called a “titanium substrate,” the TiO2 nanotubes on the substrate surface are called a “nanotube oxide layer,” and a titanium substrate with a nanotube oxide layer is called a “titania support structure” (even though, strictly speaking, the substrate itself is not titania) or a titanium support structure. Though examples and discussions herein generally focus on titanium dioxide, other metal-oxide nanotubes may be used in various embodiments. For example, zinc oxide (ZnO2), among others, may be used as a metal-oxide nanotube.

The titanium support structure may act as building blocks in various CO2-removal reactor designs that allow unique geometries and structures to be considered. Favorable performance of the integrated materials (e.g., the titanium support structure with MOFs) may increase the reactor design space allowing consideration of more energy efficient heat transfer methods and greater flexibility in gas (e.g., air) flowrate as compared to traditional configurations of a packed bed reactor containing a pelletized form of adsorbent (e.g., zeolite). The integrated structures described herein may be incorporated into open channels, which provide solutions to the general problems of adsorbent pellet degradation and attrition, which may cause downstream processing issues. Accordingly, these benefits may enable a relatively more reliable system that consumes less power and has a wider dynamic operating range to accommodate, for example, larger crews in a spacecraft cabin.

MOF adsorbents are a class of materials that enable the development of improved regenerative CO2 removal systems for life support applications. MOFs are an emerging class of materials comprising a three-dimensional lattice framework of alternating metal clusters and organic linkers. They are compositionally tunable, exhibit a very high surface area and porosity, and some types are particularly selective for CO2 adsorption.

In various embodiments, three types of MOFs, which have favorable CO2 adsorption properties and may involve simple or moderately complex chemical synthesis, may be used. For example, titania nanotubes grown from a titanium base have a very high surface area, can be mechanically stable, and may behave as an electrically conductive support material. These MOFs are herein named “MOF #1,” “MOF #2,” and “MOF #3” and are known in their literature sources as SIFSIX-3-Cu, mmen-Mg2 (dobpdc), and 2a-NiOH, respectively. MOFs #1-3 can be fully regenerable, possess higher CO2 capacity by mass than zeolites, and have significantly higher CO2/N2 and CO2/H2O selectivity than zeolites. Regarding the latter feature, for example, an MOF packed bed system need not require desiccant beds due to MOFs' reduced sensitivity or insensitivity to the presence of water. This feature may lead to reduced power consumption by approximately 40% compared to an equivalent zeolite system. In various embodiments, MOFs other than those described above may be used, and the claimed subject matter is not limited in this respect.

The function of a regenerative or non-regenerative spacecraft-based CO2 removal system may be to continually extract CO2 exhaled by the crew from the cabin environment. A fully regenerable adsorption-based system facilitates adsorption of CO2 from the cabin atmosphere and desorption/regeneration of the bed to an original state without exceeding acceptable cabin CO2 levels, which may be accomplished with parallel beds in alternating states of operation. Metrics that may determine how successfully an adsorbent may function for spacecraft regenerative CO2 removal include 1) A high CO2 loading capacity: Equilibrium uptake mass of CO2 per mass of adsorbent may determine the mass of adsorbent for a given CO2 removal rate and frequency of regeneration, 2) Regenerability: The adsorbent's working capacity to be fully regenerated under spacecraft compatible conditions after each cycle, and CO2 interaction sites to not be susceptible to contaminant poisoning, 3) Fast mass transfer: CO2 transfer from the bulk gas through the boundary layer and internal porosity to be sufficiently fast that the desired CO2 removal rate can be met with a reasonable reactor mass and volume, 4) Low pressure-drop: The power to move air through the bed can be proportional to the pressure-drop, which is reduced or minimized with appropriately sized pellets or open channel bed geometry, 5) High CO2/H2O selectivity: Water vapor is present in higher concentrations than CO2 in cabin air. An adsorbent selective for CO2 over water may decrease or eliminate the need for upstream desiccants, and 6) Cyclic stability: The adsorbent material to be able to undergo repeated cycling without an appreciable decline in CO2 adsorption capacity, regenerability, or mechanical stability. Comparing these six metrics for MOFs and zeolites, MOFs are similar to or better than zeolites in all categories, with superior CO2 loading capacity and selectivity over water.

CO2 removal systems generally are implemented in either an open-channel configuration or a packed bed configuration. The latter configuration has a few advantages, but there are a number of disadvantages. For example, 1) a packed bed configuration generally limits acceptable air flowrate range due to bed pressure drop, 2) there's a possibility that bed particles/pellets (e.g., zeolite) degrade or compact during adsorption and desorption segments of the process and throughout the lifetime of the bed, 3) pellets are often on the scale of a few millimeters such that the bulk of reaction sites are in the interior microporosity of the pellet, thus introducing significant mass transfer resistance, 4) reactor sizing may be limited by the rate of heat transfer at the external bed surface, and 5) pelleted adsorbents often use a binder, such as polyvinyl alcohol for example, to maintain pellet shape, which can add mass with no active adsorption sites.

While zeolites are a type of material that may not be amenable to coating an open-channel support structure or forming mechanically stable thin films, MOFs, due to their chemical diversity and tunability, may be synthesized and coated on support structures and deposited as thin films. Additionally, because MOFs have approximately 1.5-3 times higher CO2 capacity than zeolites, an adsorption bed design space may open up to allow consideration of an open structure with low pressure drop geometry. This implies that a MOF-packed bed may potentially be about a third of the mass and volume of a zeolite-packed bed with equivalent CO2 removal. Alternatively, for the same volume of a zeolite-packed bed, an open-channel MOF bed may be about two-thirds of the total volume available for open-channel void or support material. Generally, a goal of an efficient design of an open channel geometry is to increase or optimize the total adsorbent mass, dispersion, and arrangement to obtain a structure with reduced pressure drop (e.g., the lowest possible pressure drop), reduced mass transfer resistance (e.g., the least mass transfer resistance), and increased heat transfer (e.g., the most efficient heat transfer).

In some open-channel embodiments, a flat titania support structure with a sorbent (e.g., an MOF) coated or created as a film on its surface may be extended from a single flat sheet concept to multiple stacked sheets or a square flat channel, as described below. Other implementations may involve integrating an MOF onto hollow rods or a titanium wire mesh geometry, for example. Titanium provides a benefit as a substrate because it allows titania nanotubes to be grown directly from base titanium to provide a high surface area oxide layer for the MOFs to adhere. Titanium, as well as other metals, is also electrically and thermally conductive, which may allow for various methods of heat transfer for adsorbent regeneration. In some implementations, a heating element (other than the titanium or other metal) substrate material may be used for heat transfer. For example, such heat transfer may raise the temperature of the titania (or other metal) support structure and sorbent (e.g., an MOF), allowing for improved adsorbent regeneration. Though titanium is described in these example embodiments, other metals may be used in place of titanium and the claimed subject matter is not limited in this respect.

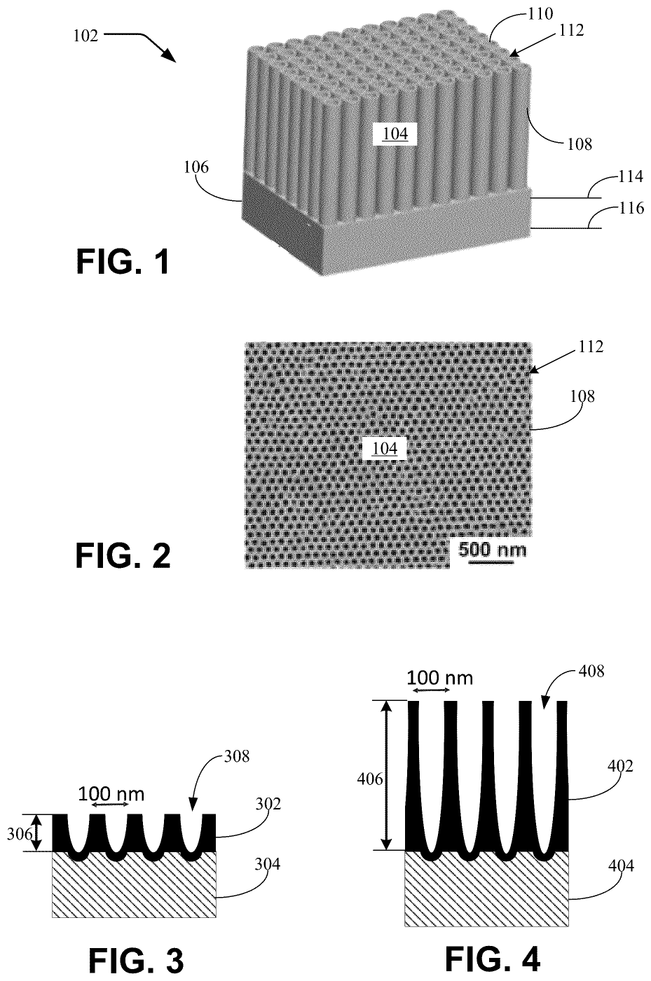

FIG. 1 is a schematic perspective view and FIG. 2 is a top view of a titania support structure 102 that includes a nanotube oxide layer 104 on a titanium substrate 106, according to some embodiments. Nanotube oxide layer 104 comprises an array of nanotubes 108, which have an inside surface 110 that may be at least partially covered with an MOF 112. Nanotubes 108 are not necessarily drawn to scale, and the height of individual nanotubes need not equal the heights of all others. In some implementations, an electrode 114 may be connected to titanium substrate 106 to carry electricity for adsorbent regeneration, as described below. In other implementations, a heating element 116 may be connected to the titanium substrate to carry heat for adsorbent regeneration.

Titania nanotube layers can be formed under a variety of different specific sets of environmental (e.g., anodization) conditions. Generally, geometry (e.g., size, shape, the degree of order, crystallized phases, etc.) and chemical and physical properties are main features influenced by these conditions of formation. Thus, by controlling electrochemical anodization parameters (e.g., applied potential, duration of anodization, the electrolyte system including the concentration of ions, water in the electrolyte, electrolyte temperature, electrolyte pH, etc.), one can fabricate different titania nanostructures such as a flat compact oxide, a porous layer, disordered TiO2 nanotube layers growing in bundles, or highly organized regular TiO2 nanotubes, such as nanotube oxide layer 104. Other examples of nanotubular layers may include branched tubes, bamboo-like tubes, double-walled tubes, and double-layer structures. TiO2 nanotube arrays with tube diameters ranging from 10 to 500 nanometers (nm), thicknesses of layers ranging from a few hundred to 1000 micrometers (μm), and wall thickness ranging from 2 to 80 nm can be obtained. FIG. 2 illustrates an example dimension of 500 nm, but claimed subject matter is not so limited.

As described above, nanotube oxide layer 104 may act as a support structure for MOF adsorbents (e.g., MOF 112), which may cover the surfaces of the nanotubes. Nanotube oxide layer 104 generally has a very high surface area, which may be of the order of 1000 square meters per gram, for example. Such a high surface area, covered with MOF adsorbents, can provide very efficient CO2 capture.

FIG. 3 is a cross-section view of a titania nanotube array 302 disposed on a titanium substrate 304, according to some embodiments. A depth 306 of the nanotubes may depend, at least in part, on anodization conditions of the titanium. FIG. 3 illustrates an example width of a nanotube opening and wall thickness of 100 nm, but claimed subject matter is not so limited. MOFs (not illustrated in this figure) may cover at least a portion of the interior surfaces 308 of nanotube array 302.

FIG. 4 is a cross-section view of another titania nanotube array 402 disposed on a titanium substrate 404, according to some embodiments. As for the case of FIG. 3, a depth 406 of the nanotubes may depend, at least in part, on anodization conditions of the titanium. FIG. 4 illustrates an example width of a nanotube opening of 100 nm, but claimed subject matter is not so limited. MOFs (not illustrated in this figure) may cover at least a portion of the interior surfaces 408 of nanotube array 402. Compared to titania nanotube array 302, based on amount of surface area, titania nanotube array 402 may accommodate a larger population of MOFs on interior surfaces 408. Considering surface area by itself, however, may not yield a complete or accurate conclusion about MOF population and accommodation. For example, as explained below, some portions of interior surfaces 408 (and 308) may not be physically accessible to MOFs. Accordingly, nanotubes may be fabricated to have a depth (e.g., 306 and 406) that corresponds to the type of MOF such that the MOFs are able to cover substantially all of the interior surface area of the nanotubes.

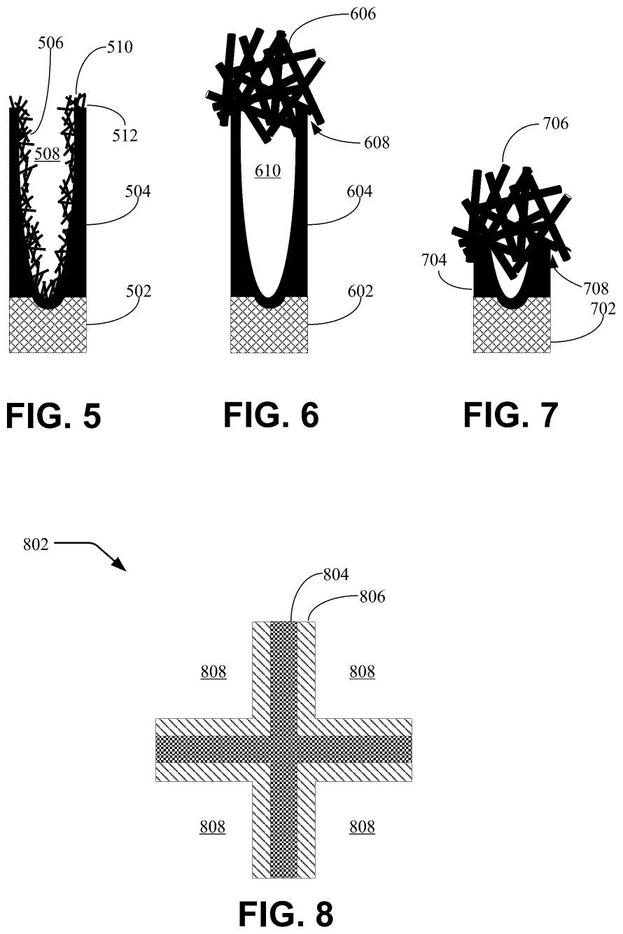

FIGS. 5-7 illustrate possible MOF coating regimes of nanotubes. Generally, the effectiveness of a CO2 (or other contaminant) entrapment, such as for an air purification system, may depend on surface area of MOF exposed to the CO2. Different coating regimes give rise to different ways that MOFs are supported by the nanotubes. Though these figures and examples describe titania nanotubes and MOFs thereon, other embodiments may involve different substrate configurations, other than nanotubes, such as membrane substrates, covalent organic frameworks (COFs), or MOFs used as a substrate, just to name a few examples.

FIG. 5 is a cross-section view of a titanium substrate 502 covered by a titania nanotube 504 including a population of MOFs 506 at least partially covering the surface of the interior 508 of the nanotube, according to some embodiments. A relatively small portion of MOFs 510 at least partially cover an entrance portion 512 of the nanotube.

FIG. 6 is a cross-section view of a titanium substrate 602 covered by a titania nanotube 604 including a population of MOFs 606 at least partially covering an entrance portion 608 of the nanotube. In this coating regime, the interior 610 of nanotube 604 is substantially absent of MOFs. In some implementations, the MOFs may be a type of MOF that is physically or chemically prevented from reaching interior portions of the nanotube. If the bonding between the MOF layer and the nanotube is sufficient for the nanotube to form a durable substrate for mechanical stability of the MOF layer, then this condition may allow the MOF layer to be grown 10×-1000× thicker than the nanotube layer, for example.

FIG. 7 is a cross-section view of a titanium substrate 702 covered by a titania nanotube 704 including a population of MOFs 706 at least partially covering an entrance portion 708 of the nanotube. In this coating regime, the interior of nanotube 704 may be partially filled with MOFs. In some implementations, this coating regime may be the same as or similar to that of FIG. 6 but applied to nanotubes having a lesser depth.

FIG. 8 is a cross-section view of a portion 802 of a support structure 804 having an MOF 806 on its surface, according to some embodiments. For example, the support structure may be a wire grid (e.g., a screen). In such a case, support structure 804 may incorporate openings 808 through which, for instance, CO2-enriched air could pass within an open-channel. As described below, CO2 may become entrapped on contact with MOF 806.

Though not illustrated in FIG. 8, the interface between support structure 804 and MOF 806 may comprise a nanotube oxide layer, which provides a relatively large surface area on which MOF 806 can reside.

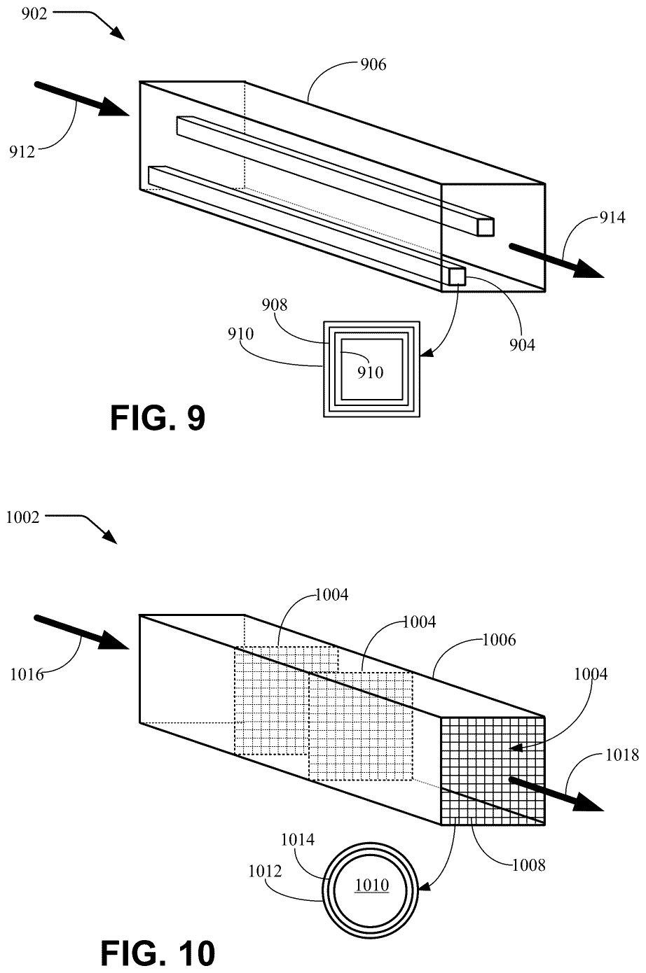

FIG. 9 is a schematic view of an open channel reactor 902 including linear structures 904 (e.g., sheets or rods) that support MOFs, according to some embodiments. In various examples, linear structures 904 may be hollow (having circular, triangular, or rectangular cross-sections). Reactor 902 may comprise an open channel 906 to contain a plurality of linear structures 904, which may comprise a support structure and an MOF. In a particular implementation, support structure 904 may comprise a hollow titania support structure 908 that is at least partially covered with an MOF 910 on its outside and/or interior surfaces. This is illustrated as a cross-section inset in FIG. 9. Though not illustrated, the interfaces between support structure 908 and MOFs 910 may comprise a nanotube oxide layer, which provides a relatively large surface area on which MOFs 910 can reside.

In some particular implementations, linear structures 904 may have a width and height of about 2 mm. Hollow titania support structure 908 may have a thickness of about 200 μm. MOFs 910 may reside in nanotubes of the nanotube oxide layer.

As CO2-enriched air 912 flows into open channel 906 and past the plurality of MOF-supporting linear structures, the CO2 may be captured upon contact with the MOF. Air 914 exiting open channel 906 may be ideally void of CO2. In a more realistic example, air 914 may have a relatively low concentration of CO2 to CO2-enriched air 912 and may be guided into a subsequent (e.g., second-stage) open channel reactor to further remove CO2.

FIG. 10 is a schematic view of an open channel reactor 1002 including wire mesh structures 1004 that support MOFs, according to some embodiments. The wire mesh structures may be the same as or similar to support structure 804, for example.

Reactor 1002 may comprise an open channel 1006 to contain a plurality of wire mesh structures 1004. The wire mesh structures comprise wire 1008 as a support structure and an MOF. More specifically, the support structure may be a titania support structure 1010, which is at least partially covered with an MOF 1012, illustrated as a cross-section of a portion of wire mesh structure 1004 in FIG. 10. The interface between support structure 1010 and MOF 1012 may comprise a nanotube oxide layer 1014, which provides a relatively large surface area on which MOF 1012 can reside.

In some particular implementations, wire mesh structures 1004 may have a wire-to-wire spacing of about 500 μm. Wire 1008 may have a diameter of about 180 μm, and a diameter of wire 1008 plus MOFs 1012 may be about 200 μm.

As CO2-enriched air 1016 flows into open channel 1006 and past the plurality of MOF-supporting wire mesh structures, the CO2 may be captured upon contact with the MOF. Air 1018 exiting open channel 1006 may be ideally void of CO2. In a more realistic example, air 1018 may have a relatively low concentration of CO2 relative to CO2-enriched air 1016 and may be guided into a subsequent (e.g., second-stage) open channel reactor to further remove CO2.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

What is claimed is:

1. A carbon dioxide (CO2) removal reactor system comprising:
a metal substrate having a surface;
a nanotube oxide layer on the surface of the metal substrate; and
a metal organic framework (MOF) adsorbent disposed on the nanotube oxide layer.

2. The CO2 removal reactor system of claim 1, wherein the metal substrate is a wire mesh.

3. The CO2 removal reactor system of claim 1, wherein the metal substrate is a sheet or hollow rod.

4. The CO2 removal reactor system of claim 1, wherein the metal substrate is a titanium substrate.

5. The CO2 removal reactor system of claim 1, wherein the MOF is disposed inside individual nanotubes of the nanotube oxide layer.

6. The CO2 removal reactor system of claim 1, wherein the MOF is disposed substantially at openings of individual nanotubes of the nanotube oxide layer.

7. The CO2 removal reactor system of claim 1, further comprising an electrode connected to the metal substrate to carry electricity to regenerate at least a portion of the CO2 removal reactor system.

8. The CO2 removal reactor system of claim 1, further comprising a heating element connected to the metal substrate to carry heat to regenerate at least a portion of the CO2 removal reactor system.

9. A carbon dioxide (CO2) removal system comprising:
an open channel that includes
a metal substrate having a surface;
a nanotube oxide layer on the surface of the metal substrate; and
a metal organic framework (MOF) adsorbent disposed on the nanotube oxide layer.

10. The CO2 removal system of claim 9, wherein the metal substrate is a wire mesh that extends across at least a portion of the open channel.

11. The CO2 removal system of claim 9, wherein the metal substrate is a sheet or hollow rod that is oriented longitudinally in the open channel.

12. The CO2 removal system of claim 9, wherein the CO2 removal system is disposed in a spacecraft.

13. The CO2 removal system of claim 9, wherein the metal substrate is a titanium substrate.

14. The CO2 removal system of claim 9, wherein the MOF is disposed inside individual nanotubes of the nanotube oxide layer.

15. The CO2 removal system of claim 9, further comprising an electrode connected to the metal substrate to carry electricity to regenerate at least a portion of the CO2 removal reactor system.

16. The CO2 removal system of claim 9, further comprising a heating element connected to the metal substrate to carry heat to regenerate at least a portion of the CO2 removal reactor system.

17. A method of removing carbon dioxide (CO2) from a cabin of a spacecraft, the method comprising:
conveying air from the cabin into an open channel and past a titania support structure located in an open channel, wherein the air includes CO2 and the titania support structure includes a metal organic framework (MOF) adsorbent; and
providing the air that has passed the titania support structure to the cabin.

18. The method of claim 17, wherein the titania support structure is a wire mesh that extends across at least a portion of the open channel.

19. The method of claim 17, wherein the titania support structure is a sheet that is oriented longitudinally in the open channel.

20. The method of claim 17, wherein the titania support structure is a rod that is oriented longitudinally in the open channel.
